(19) United States
(12) Patent Application Publication
(10) Pub. No.: US 2005/0220574 A1
(43) Pub. Date: Oct. 6, 2005

(54) Production device and production equipment

(76) Inventors: Yu-Chang Chen, Tainan City (TW); Po-Hung Wang, Jhonghe City (TW)

Correspondence Address: BIRCH STEWART KOLASCH & BIRCH, PO BOX 747, FALLS CHURCH, VA, 22040-0747, US

(21) Appl. No.: 10/947,309

(22) Filed: Sep. 23, 2004

(30) Foreign Application Priority Data
Jan. 9, 2004 (TW) 093100572

(51) Int. Cl. B60T 8/24

(52) U.S. Cl. 414/150

(57) ABSTRACT

A production device monitors a transporting status of a circuit board in production equipment. The production device includes a transporting unit, a holding unit and at least one detecting unit. In this case, the transporting unit transports the circuit board. The holding unit is set in the production equipment and at least one part of the holding unit is disposed below the transporting unit. The detecting unit is disposed on the production equipment. The detecting unit is connected to and cooperated with the holding unit. Furthermore, production equipment, including a machine housing, a transporting unit, a holding unit, and at least one detecting unit, is disclosed.

### BACKGROUND OF THE INVENTION

1. Field of Invention

The invention relates to a production device and equipment, and, in particular, for a production device and equipment of circuit boards, which detects whether the circuit board falls down or not.

2. Related Art

Because of the progress and development of the electronic industry, the newest electronic products always have more advanced and complicated functions for providing a more convenient and comfortable life. However, when the performances of chips are promoted, the amounts of leads for packaging components on the printed circuit boards (PCBs) are also continuously increased. Thus the layout of the printed circuit board becomes more delicate and complex, and it is difficult to mount and solder components thereon.

In general, the key factor of the yields of mounting assembly parts onto printed circuit boards is the leads soldering procedure of components. In prior art, the wave soldering procedures are mainly applied to assembly printed circuit boards for furthering mass productions. In a wave soldering process, the molten solder is driven by a motor pump and forced upward into the through holes beneath the printed circuit boards which are transported to pass the soldering wave.

Referring to FIG. 1, the conventional wave soldering apparatus 1 includes a transporting unit 11, a sprayer 12, a preheating area 13, and a soldering bath 14. The transporting unit 11 conveys a circuit board 15. The sprayer 12 sprays flux to the circuit boards 15. The preheating area 13 preheats the circuit board 15. Finally, the circuit board 15 is transferred to the soldering bath 14 to perform the wave soldering process.

The circuit board 15 is sprayed with flux and preheated in advance. The reason for applying the flux to the circuit is to clean the surfaces of the soldering metal and to improve the solderability. Besides, the preheating process of the circuit board has following functions: a) dispelling the volatility compounds of the flux to reduce the splashed solder and cavities formed in the soldering points; b) raising the temperatures of the circuit boards to reduce the damages caused by thermal stress and improving the capability of filling molten solder into the through holes; and c) enhancing the flux activity and ability so as to make it easier to clean the oxides or contaminant on the surface of the solder.

In addition, there are detector 161 and detector 162 disposed separately at the entrance and exit parts of the wave soldering apparatus 1. In order to identify if the circuit boards are transported smoothly, the detectors 16, including the detectors 161 and 162, detect the distance between two circuit boards transferred with a constant speed. In this case, the falling of the circuit board cannot be detected immediately. In other words, when the circuit board falls at the entrance part of the wave-soldering apparatus, it would not be detected. The warning signal, then, would not be sent out until the detector 162 of the exit part detects the changing interval between the circuit boards. Then, the operator stops the wave soldering process manually when receiving the Warning signal.

Especially when the interval between two circuit boards is smaller than 5 mm, the detectors 16 may misjudge them as a single circuit board. If one of them falls to the preheating area 13, the detectors 161 will not send out the warning signal to alert the operators. Only after the circuit board 15 and its jig are deformed and damaged by high temperature accompanying bad smell, the operators know the board falling down to the preheating area 13. Accordingly, the circuit board 15 and its jig cannot be saved, and the machine cannot be shut down in real time, which increases the cost of production.

As described above, it is an important subjective to provide a production device and equipment thereof for solving the above-mentioned problems.

### SUMMARY OF THE INVENTION

In view of the foregoing, this invention is to provide a production device and production equipment, which can detect the falling circuit board in real time.

To solve the above-mentioned problems, a production device monitors a transporting status of a circuit board transported in production equipment. The production device of the invention includes a transporting unit, a holding unit and at least one detecting unit. The transporting unit transports the circuit board. The holding unit is set in the production equipment, and at least one part of the holding unit is disposed below the transporting unit. The detecting unit is disposed on the production equipment. The detecting unit is connected to and cooperated with the holding unit.

The invention further provides production equipment, which includes a machine housing, a transporting unit, a holding unit, and at least one detecting unit. The transporting unit, which is set in the machine housing, transports the circuit board. The holding unit is set in the machine housing, and at least one part of the holding unit is disposed below the transporting unit. The detecting unit, which is set on the machine housing, is connected and actuated mutually with the holding unit.

As mentioned above, the production device and production equipment of the invention utilize the holding unit, which connects with the production equipment, to hold the falling circuit board, so that the circuit board would not drop on the heat pipe or other place of the production equipment. As the time as the circuit board falling on the holding unit, the detecting unit, which connects and actuates with the holding unit, sends out a warning signal to stop the process of the equipment. Compared to the prior art, the invention can detect the falling of the circuit board in real time. Besides, the holding unit of the invention can hold the falling circuit board and alert the operators to take it out immediately. Consequently, the circuit board and its jig would not be deformed and damaged. As described above, the production device and production equipment of the invention not only can detect the falling circuit board in the real time, but also can help the operators to shut down the machine immediately. The circuit board and its jig, which are taken out by the operators, can be reused, and the equipment can be restarted rapidly. Therefore, the restarting time is saved, and the materials are prevented from being wasted.

### BRIEF DESCRIPTION OF THE DRAWINGS

The invention will become more fully understood from the detailed description given herein below illustrations only, and thus is not limitative of the present invention, and wherein:

FIG. 1 is a schematic view of the conventional wave soldering apparatus and its detectors;

FIG. 2 is a schematic lateral view of the production device and production equipment of the invention;

FIG. 3 is a schematic three-dimensional view of the production device and production equipment of the invention;

FIG. 4 is a schematic view of the holding unit actuated with the detecting unit of the invention, wherein the holding unit is a steel rope; and

FIG. 5 is a schematic view of the holding unit actuated with the detecting unit of the invention, wherein the holding unit is a metal strip.

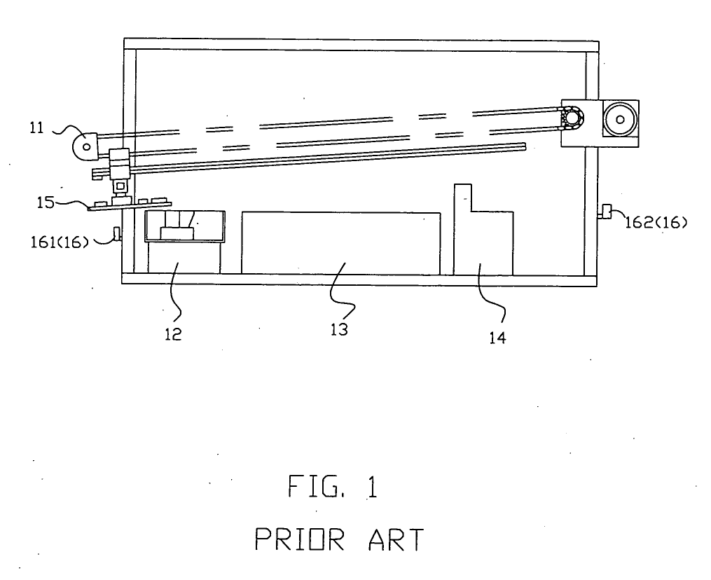

### DETAILED DESCRIPTION OF THE INVENTION

The production device and production equipment according to preferred embodiments of the invention will be described herein below with reference to the accompanying drawings, wherein the same reference numbers refer to the same elements.

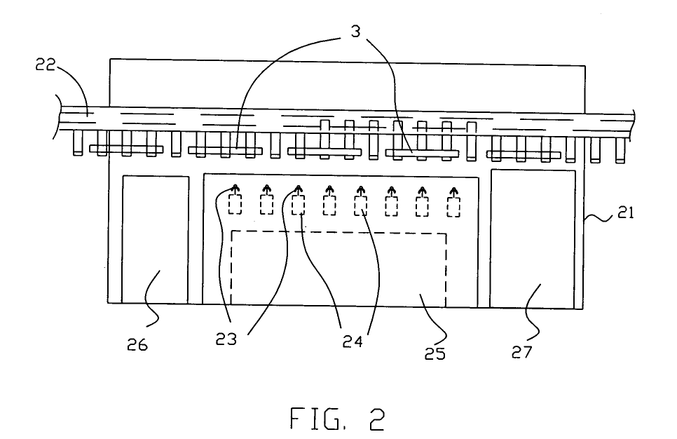

Referring to FIG. 2, production equipment according to a preferred embodiment of the invention will be described. The production equipment not only indicates any equipment needed in the production process, but also that needed in the quality controlling process, and maintenance process. The production equipment could be, for example, soldering equipment, cooling equipment, film plating equipment, or the likes. Herein, wave-soldering equipment is taken for example as a preferred embodiment of the invention.

Referring to FIG. 2, production equipment includes a machine housing 21, a transporting unit 22, a holding unit 23 and at least one detecting unit 24.

The machine housing 21 includes a base and shell parts. In the current embodiment, the machine housing 21 of the wave soldering equipment is illustrated.

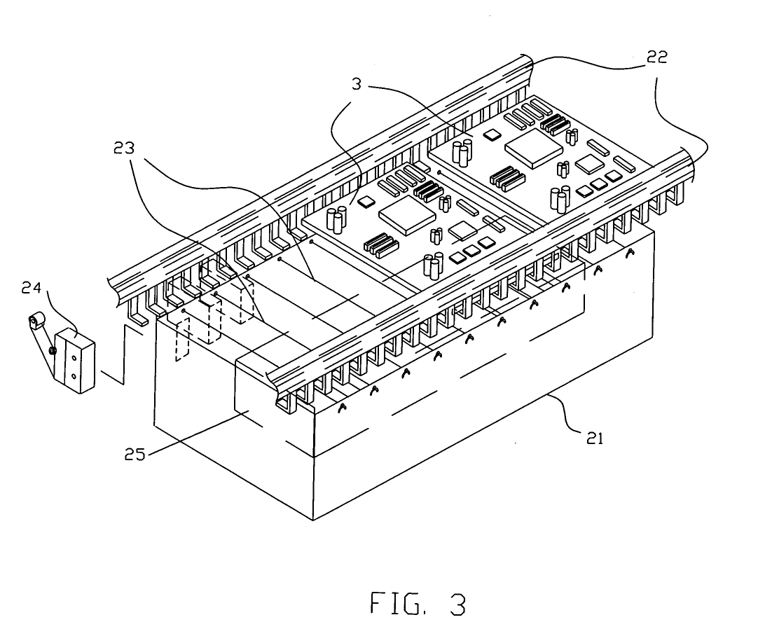

As shown in FIG. 3, the transporting unit 22, which is set in the machine housing 21, transports a circuit board 3. The transporting unit 22 can be a flat type rail with small clamps, or can be a three-dimensional reciprocating rail with clamps. The transporting unit 22 transports the circuit boards 3 between each unit of the wave soldering equipment, so as to complete the processes of wave-soldering. The circuit board 3 includes the clamping jig(s) used for the board.

The holding unit 23 is set in the machine housing 21, and at least one part of the holding unit 23 is disposed below the transporting unit 22. The holding unit 23 is to hold the falling circuit board 3, and prevents the circuit board 3 falling into the other units of the production equipment. The holding unit 23 includes a plurality of steel ropes. The ropes can be crossed to each other, and forms a tight steel rope net, which makes the holding unit 23 forming a net-like structure.

The detecting unit 24, which is set on the machine housing 21, is connected and cooperated with the holding unit 23. The detecting unit 24 includes a detector, which is a limit switch detector or a ultra-red detector. The switch part of each limit switch detector connects to the holding unit 23. When the weight of where the switch part connects has changed, the switch is turn on and sends out a signal. The ultra-red detector detects if any object passing through the light path based on the optical principle.

The production equipment of the invention further includes a heating unit 25, and the transporting unit 22 transports the circuit board 3 to pass the heating unit 25. The heating unit 25 is for heating the circuit board 3. The heating unit 25 includes a heating plate or heating pipe. In the current embodiment, the heating unit 25 is a preheating unit of the wave soldering equipment, and the heating unit 25 is a heating pipe.

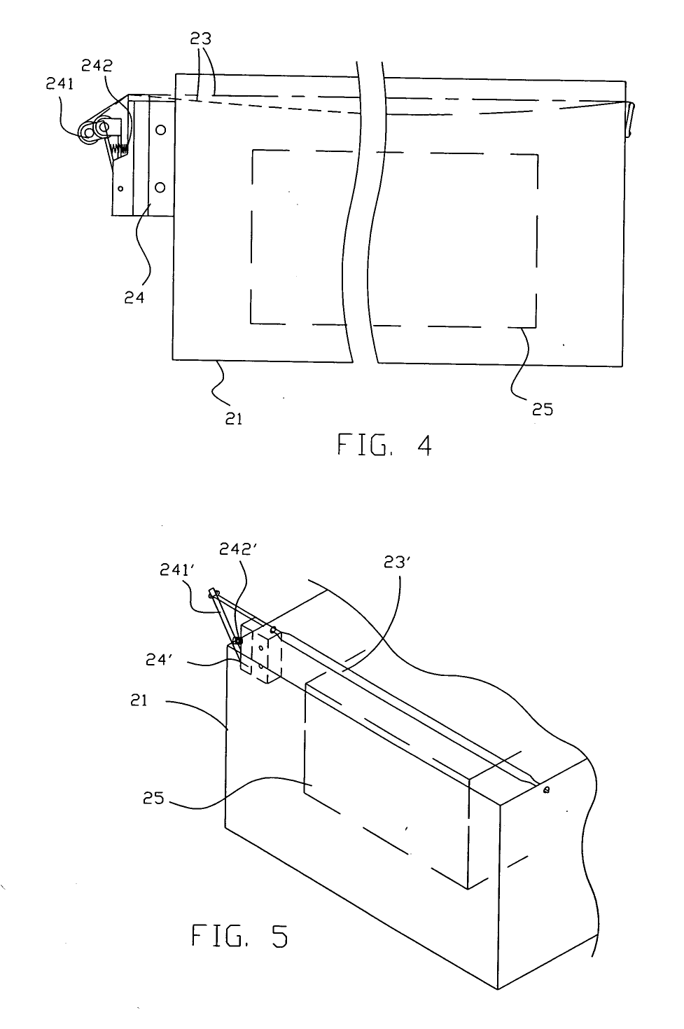

According to FIG. 4, in the present embodiment, the holding unit 23 connects with the wave soldering equipment. One end of the steel rope is fixed on one side of the machine housing 21 of the production equipment, and the other end of the steel rope passes the opposite side of the machine housing 21 of the production equipment and connects with the detecting unit 24. Regarding to fix the steel ropes on the machine housing 21, holes on the sidewall of the heating unit 25 are drilled, and one end of the steel rope passes the hole and is then fixed. The other end of the steel rope connects with the wheel bar 241 of the detecting unit 24. When the circuit board 3 falls carelessly, the holding unit 23 catches it. The steel ropes are then pulled down (shown as the dashed line) by the weight of the circuit board 3, so that the bar wheel 241 is drawn. Then, the spring 242 of the detecting unit 24 is pressed to turn on the switch, and the detecting unit 24 sends out a warning signal to the operator.

Referring to FIG. 5, the holding unit 23′ includes a plurality of metal strips. One end of the steel strip is fixed on one side of the machine housing 21, while the other end of the steel strip passes the opposite side of the machine housing 21 and connects with the detecting unit 24′. Considering of fixing the steel strip, holes on the sidewall of the machine housing 21 are drilled, and one end of the steel rope passes the hole and is then fixed on it. The other end of the steel strip has a hole to hang this end on the pressed bar 241′ of the detecting unit 24′. When the circuit board 3 falls carelessly, the holding unit 23′ catches it. The steel strips are then pulled down (shown as the dashed line) by the weight of the circuit board 3, so that the pressed bar 241′ is drawn. Then, the spring 242′ of the detecting unit 24′ are pressed to turn on the switch, and the detecting unit 24′ sends out a warning signal to the operator.

Moreover, the production equipment further includes a controller. When receiving the warning signal indicating the falling of the circuit board, which sends out from the detecting unit 23 (or 23′), the controller sends out a shut down signal, and make the production equipment shut down without manually operating by operators so as to save time. After the equipment stops, the operators can then pick up the falling circuit board immediately. Consequently, it will avoid the circuit board and its jig from deforming and damaging by the high temperature, which lead to the material waste.

Referring to FIG. 2 again, it shows the schematic lateral view of the production equipment and device thereof. Wave soldering equipment is taken for example as the production equipment of the invention. In addition to the transporting unit 22 and heating unit 25, the wave-soldering equipment further includes a spraying unit 26 and a soldering bath unit 27. In this case, the spraying unit 26 is for spraying the flux to the circuit board 3. The soldering bath unit 27 accommodates the molten soldering metal in it. By the projected soldering wave, the wave-soldering step of the circuit board 3 is performed.

As shown in FIG. 3, the production device according to a preferred embodiment of the invention is described.

A production device is provided in production equipment. The production equipment not only indicates any equipment needed in the production process, but also that needed in the quality controlling process, and maintenance process. The production equipment could be, for example, soldering equipment, cooling equipment, film plating equipment, and the likes. The production device is for monitoring the transporting status of a circuit board 3. Herein, a wave soldering apparatus is taken for example as a preferred embodiment of the invention.

FIG. 3 illustrates a production device according to a preferred embodiment of the invention, which includes a transporting unit 22, a holding unit 23, and at least one detecting unit 24.

The transporting unit 22, which is set in the production equipment, transports a circuit board 3. The transporting unit 22 can be a flat type rail with small clamps, or can be a three-dimensional reciprocating rail with clamps. The transporting unit 22 transports the circuit boards 3 between each unit of the wave soldering equipment, so as to complete the processes of wave soldering. The circuit board 3 includes the clamping jig used for the board.

The holding unit 23 is set in the production equipment, and at least one part of the holding unit 23 is disposed below the transporting unit 22. The holding unit 23 is to hold the falling circuit board 3, and prevents the circuit board 3 falling into the other units of the production equipment. The holding unit 23 includes a plurality of steel ropes. The ropes can be crossed to each other, and forms a tight steel rope net, which makes the holding unit 23 forming a net-like structure.

The detecting unit 24, which is set on the production equipment, is connected and actuated mutually with the holding unit 23. The detecting unit 24 includes a detector, which is a limit switch detector or a ultra-red detector. The switch part of each limit switch detector connects to the holding unit 23. When the weight of where the switch part connects has changed, the switch is turned on and sends out a signal. The ultra-red detector detects if any object passing through the light path based on the optical principle.

The production device of the invention is provided in the production equipment, which further includes a heating unit 25. The transporting unit 22 transports the circuit board 3 to pass the heating unit 25. The heating unit 25 is for heating the circuit board 3. The heating unit 25 includes a heating plate or heating pipe. In current embodiment, the heating unit 25 is a preheating unit of the wave soldering equipment, and the heating unit 25 is a heating pipe.

According to FIG. 4, in the present embodiment, the holding unit 23 connects with the wave soldering equipment. One end of the steel rope is fixed on one side of the machine housing 21 of the production equipment, and the other end passes the opposite side of the machine housing 21 of the production equipment and connects with the detecting unit 24. Regarding to fix the steel ropes, holes on the machine housing 21 of the equipment are drilled, and one end of the steel rope passes the hole and is then fixed. The other end of the steel rope connects with the wheel bar 241 of the detecting unit 24. When the circuit board 3 falls carelessly, the holding unit 23 will catch it. The steel ropes are pulled down (shown as the dashed line) by the weight of the circuit board 3, which draws the bar wheel 241. Then, the spring 242 of the detecting unit 24 are pressed to turn on the switch, and the detecting unit 24 will send out a warning signal to the operator.

Referring to FIG. 5, the holding unit 23′ includes a plurality of metal strips. One end of the steel strip is fixed on one side of the machine housing 21, while the other end passes the opposite side of the machine housing 21 and connects with the detecting unit 24′. Regarding of fixing the steel strips, a hole on the sidewall of the machine housing 21 is drilled, and one end of the steel rope passes the hole and is then fixed. The other end of the steel strip has a hole to loop on the pressed bar 241′ of the detecting unit 24′. When the circuit board 3 falls carelessly, the holding unit 23′ will catch it. The steel strips are pulled down (shown as the dashed line) by the weight of the circuit board 3, which draws the pressed bar 241′. Then, the spring 242′ of the detecting unit 24′ are pressed to turn on the switch, and the detecting unit 24′ will send out a warning signal to the operator.

As mentioned above, the production device and production equipment of the invention utilize the holding unit, which connects with the production equipment, to hold the falling circuit board, and make it not to drop on the heat pipe or other place of the production equipment. When the circuit board falling on the holding unit, the detecting unit, which connects and actuates with the holding unit, sends out a warning signal and stops the production equipment. Compared to the prior art, the invention has the real time detecting function. Besides, the holding unit of the invention can hold the falling circuit board and let the operators take it out immediately. Consequently, the circuit board and its jig would not be deformed and damaged. As a result, the production device and production equipment of the invention not only can detect the falling circuit board in real time, but also can help the operators to shut down the production equipment immediately. The circuit board and its jig, which are taken out by the operators, can be reused, and the operator can restart the equipment rapidly. It can save the restarting time and avoid the materials being wasted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A production device, which monitors a transporting status of a circuit board transported in production equipment, comprising:
a transporting unit, which is set in the production equipment and transports the circuit board;
a holding unit, which is set in the production equipment, wherein at least one part of the holding unit is disposed below the transporting unit; and
at least one detecting unit, which is set on the production equipment, wherein the detecting unit is connected to and cooperated with the holding unit.

2. The production device of claim 1, wherein the production equipment further comprising a heating unit and the transporting unit transports the circuit board to pass the heating unit.

3. The production device of claim 2, wherein the holding unit is a net-like structure and is disposed above the heating unit.

4. The production device of claim 1, wherein the holding unit comprises a plurality of steel ropes, one end of each of the steel rope is fixed on one side of the production equipment, and the other end of each of the steel rope passes an opposite side of the production equipment and connects with the detecting unit.

5. The production device of claim 1, wherein the holding unit comprises a plurality of steel strips, one end of each of the steel strip passes one side of the production equipment, and the other end of each of the steel strip passes an opposite side of the production equipment and connects with the detecting unit.

6. The production device of claim 1, wherein the detecting unit comprises a detector.

7. The production device of claim 6, wherein the detector is a limit switch detector.

8. The production device of claim 1, wherein the production equipment further comprises a controller, and the controller sends out a shut down signal after receiving signals from the detecting unit.

9. The production device of claim 1, wherein the production equipment is a soldering equipment.

10. The production device of claim 9, wherein the soldering equipment is a wave soldering apparatus.

11. A production equipment, comprising:
a machine housing;
a transporting unit, which is set in the machine housing and transports a circuit board;
a holding unit, which is set in the machine housing, wherein at least one part of the holding unit is disposed below the transporting unit; and
at least one detecting unit, which is set in the machine housing and is connected to and cooperated with the holding unit.

12. The production equipment of claim 11, wherein the production equipment further comprising a heating unit and the transporting unit transports the circuit board to pass the heating unit.

13. The production equipment of claim 12, wherein the holding unit is a net-like structure, and the holding unit is disposed above the heating unit.

14. The production equipment of claim 11, wherein the holding unit comprises a plurality of steel ropes, one end of each of the steel rope is fixed on one side of the production equipment, and the other end of each of the steel rope passes an opposite side of the production equipment and connects with the detecting unit.

15. The production equipment of claim 11, wherein the holding unit comprises a plurality of steel strips, one end of each of the steel strip passes one side of the production equipment, and the other end of each of the steel strip passes an opposite side of the production equipment and connects with the detecting unit.

16. The production equipment of claim 11, wherein the detecting unit comprises a detector.

17. The production equipment of claim 16, wherein the detector is a limit switch detector.

18. The production equipment of claim 11, wherein the production equipment further comprises a controller, and the controller sends out a shut down signal after receiving signals from the detecting unit.

19. The production equipment of claim 11, wherein the production equipment is a soldering equipment.

20. The production equipment of claim 19, wherein the soldering equipment is a wave soldering apparatus.
